(19) United States
(12) Patent Application Publication
(10) Pub. No.: US 2025/0222395 A1
(43) Pub. Date: Jul. 10, 2025

(54) MEMBRANES FOR THE SEPARATION OF H2S FROM H2S-CO2 MIXTURES

(71) Applicant: Ohio State Innovation Foundation, Columbus, OH (US)

(72) Inventors: W.S. Winston HO, Columbus, OH (US); Yang HAN, Columbus, OH (US); Shraavya RAO, Columbus, OH (US)

(21) Appl. No.: 18/852,806

(22) PCT Filed: Jan. 30, 2023
(86) PCT No.: PCT/US23/61538

§ 371 Date: Sep. 30, 2024

Related U.S. Application Data
(60) Provisional application No. 63/325,429, filed on Mar. 30, 2022.

(51) Int. Cl. B01D 53/22; B01D 69/02; B01D 69/10; B01D 71/38

(52) U.S. Cl. CPC B01D 53/228; B01D 69/02; B01D 69/1071; B01D 71/381; B01D 2256/22; B01D 2257/304; B01D 2325/36

(57) ABSTRACT

Membranes, methods of making the membranes, and methods of using the membranes are described herein. The membrane can include a support layer; and a selective polymer layer disposed on the support layer. The selective polymer layer can include a selective polymer matrix that comprises a mobile carrier comprising a sterically hindered amine or a salt thereof. The selective polymer matrix can further comprise, for example, a hydrophilic polymer, a cross-linking agent, an amine-containing polymer, or a combination thereof. The membranes can be used to separate hydrogen sulfide from carbon dioxide. Also provided are methods of purifying syngas using the membranes described herein.

### CROSS-REFERENCE TO RELATED APPLICATIONS

This application claims benefit of U.S. Provisional Application No. 63/325,429, filed Mar. 30, 2022, which is hereby incorporated herein by reference in its entirety.

### STATEMENT REGARDING FEDERALLY SPONSORED RESEARCH OR DEVELOPMENT

This disclosure was made with Government Support under Grant No. DE-FE0031635 awarded by U.S. Department of Energy. The Government has certain rights to this disclosure.

### BACKGROUND

The Integrated Gasification Combined Cycle (IGCC) system is based on the gasification of coal to generate synthesis gas (syngas) that is then used for power generation. Coal is converted to syngas in a high-pressure gasifier. The raw syngas from the gasifier consists mostly of CO and H₂ and is taken through a water gas shift (WGS) reaction (CO+H₂O⇄CO₂+H₂) to generate a more efficient hydrogen-rich fuel. The shifted syngas requires an additional cleaning step before being used for electricity generation.

The hot syngas exiting the WGS reactor contains mainly H₂ (45%) and CO₂ (30%), along with water vapor (˜20-25%) and H₂S (˜0.5%) [1]. In pre-combustion carbon capture (PrCC), CO₂ is separated from H₂ to generate a clean hydrogen-rich fuel. Current technologies for CO₂ separation from H₂ include amine scrubbing, physical absorbents such as Selexol® or Rectisol®, and pressure swing adsorption. Membrane technology is an attractive and economic alternative to the abovementioned technologies due to its potentially lower energy requirement, operational simplicity, and system compactness.

In particular, CO₂-selective amine-containing membranes reinforced with inorganic nanofillers have shown good performance for high pressure CO₂/H₂ separations [2, 3]. For example, a 2-stage membrane process for CO₂ removal from syngas has been proposed [4]. A simplified schematic of the proposed process is shown in FIG. 1. The high-pressure syngas from the WGS reactor is fed to the CO₂-selective membrane, which removes both CO₂ and H₂S from syngas. The retentate from the membrane consists of >90% H₂ and is used for power generation. The permeate stream contains mostly CO₂, H₂S and H₂O and is sent to the Selexol® absorption process to remove H₂S from CO₂. The H₂S-rich stream is sent to the Claus process for sulfur production, and the desulfurized CO₂ is recompressed for sequestration.

It is suggested that the cost of electricity increase of 17.6% associated with this proposed process could potentially be reduced by replacing the Selexol® solvent absorption process with a cost-effective H₂S-selective membrane process for the separation of H₂S from CO₂ [4, 5]. The permeate stream after H₂ purification contains about 1% H₂S and 90% CO₂, while the Claus process typically requires the feed to have the H₂S content in excess of 30%. Typical amine-containing membranes show H₂S/CO₂ selectivities of about 3 [4], which is insufficient to enrich the H₂S content from 1% to 30%. Hence, there is a need for membranes with higher H₂S/CO₂ selectivity.

### SUMMARY

Disclosed herein are selective membranes that can exhibit high H₂S/CO₂ selectivity. The membranes can be used to separate hydrogen sulfide from gas streams including hydrogen sulfide and carbon dioxide.

For example, provided herein are membranes that comprise a support layer, and a selective polymer layer disposed on the support layer. The selective polymer layer can comprise a selective polymer matrix.

The support layer can be a gas permeable layer comprising a gas permeable polymer. The gas permeable polymer can comprise a polyamide, a polyimide, a polypyrrolone, a polyester, a sulfone-based polymer, a polymeric organosilicone, a fluorinated polymer, a polyolefin, a copolymer thereof, or a blend thereof. In some embodiments, the gas permeable polymer can comprise a polyethersulfone. In certain cases, the support layer can comprise a gas permeable polymer disposed on a base (e.g., a nonwoven fabric such as a polyester nonwoven).

The selective polymer matrix can comprise a mobile carrier comprising a sterically hindered amine or a salt thereof. The selective polymer matrix can further comprise, for example, a hydrophilic polymer, a cross-linking agent, an amine-containing polymer, or a combination thereof.

In some embodiments, the mobile carrier (e.g., the sterically hindered amine or salt thereof) can have a molecular weight of less than 1,000 Da.

In some embodiments, the mobile carrier comprises a compound defined by the structure below:

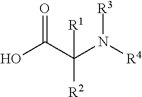

or a salt thereof, wherein
R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R¹ can be selected from alkyl, alkenyl, alkynyl, cycloalkyl, heterocycloalkyl, aryl, and heteroaryl, each optionally substituted with one or more substituents individually chosen from R^{a}. In certain embodiments, R¹ and R² are each independently selected from alkyl, alkenyl, alkynyl, cycloalkyl, heterocycloalkyl, aryl, and heteroaryl, each optionally substituted with one or more substituents individually chosen from R^{a}.

In some embodiments, R³ is hydrogen. In other embodiments, R³ and R⁴ are each independently selected from alkyl, alkenyl, alkynyl, cycloalkyl, heterocycloalkyl, aryl, and heteroaryl, each optionally substituted with one or more substituents individually chosen from R^{a}.

In some embodiments, the mobile carrier comprises a compound defined by the structure below:

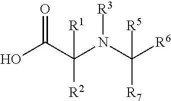

or a salt thereof, wherein R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁵ and R⁶ are independently selected from hydrogen, alkyl, alkenyl, alkynyl, cycloalkyl, heterocycloalkyl, aryl, and heteroaryl, each optionally substituted with one or more substituents individually chosen from R^{a};
R⁷ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R¹ can be selected from alkyl, alkenyl, alkynyl, cycloalkyl, heterocycloalkyl, aryl, and heteroaryl, each optionally substituted with one or more substituents individually chosen from R^{a}. In certain embodiments, R¹ and R² are each independently selected from alkyl, alkenyl, alkynyl, cycloalkyl, heterocycloalkyl, aryl, and heteroaryl, each optionally substituted with one or more substituents individually chosen from R^{a}.

In some embodiments, R³ is hydrogen. In other embodiments, R³ is selected from alkyl, alkenyl, alkynyl, cycloalkyl, heterocycloalkyl, aryl, and heteroaryl, each optionally substituted with one or more substituents individually chosen from R^{a}.

In some embodiments, R⁵ can be selected from alkyl, alkenyl, alkynyl, cycloalkyl, heterocycloalkyl, aryl, and heteroaryl, each optionally substituted with one or more substituents individually chosen from R^{a}. In certain embodiments, R⁵ and R⁶ are each independently selected from alkyl, alkenyl, alkynyl, cycloalkyl, heterocycloalkyl, aryl, and heteroaryl, each optionally substituted with one or more substituents individually chosen from R^{a}.

In some embodiments, the mobile carrier comprises a compound defined by the structure below:

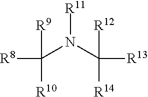

or a salt thereof, wherein
R¹ and R⁹ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁰ is selected from alkyl, alkenyl, alkynyl, cycloalkyl, heterocycloalkyl, aryl, and heteroaryl, each optionally substituted with one or more substituents individually chosen from R^{a};
R¹¹ is selected from hydrogen, alkyl, alkenyl, alkynyl, cycloalkyl, heterocycloalkyl, aryl, and heteroaryl, each optionally substituted with one or more substituents individually chosen from R^{a};
R¹² and R¹³ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R⁸ can be selected from alkyl, alkenyl, alkynyl, cycloalkyl, heterocycloalkyl, aryl, and heteroaryl, each optionally substituted with one or more substituents individually chosen from R^{a}. In certain embodiments, R⁸ and R⁹ are each independently selected from alkyl, alkenyl, alkynyl, cycloalkyl, heterocycloalkyl, aryl, and heteroaryl, each optionally substituted with one or more substituents individually chosen from R^{a}.

In some embodiments, R¹¹ is hydrogen. In other embodiments, R¹¹ is selected from alkyl, alkenyl, alkynyl, cycloalkyl, heterocycloalkyl, aryl, and heteroaryl, each optionally substituted with one or more substituents individually chosen from R^{a}.

In some embodiments, R¹² can be selected from alkyl, alkenyl, alkynyl, cycloalkyl, heterocycloalkyl, aryl, and heteroaryl, each optionally substituted with one or more substituents individually chosen from R^{a}. In certain embodiments, R¹² and R¹³ are each independently selected from alkyl, alkenyl, alkynyl, cycloalkyl, heterocycloalkyl, aryl, and heteroaryl, each optionally substituted with one or more substituents individually chosen from R^{a}.

In some examples, the mobile carrier can be one of the following

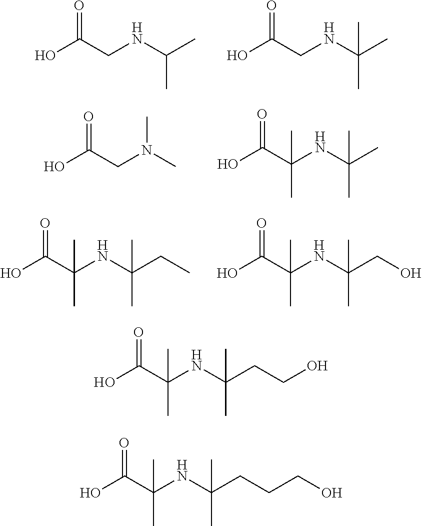

The membranes can be used to separate hydrogen sulfide from carbon dioxide. The membranes can exhibit selective permeability towards gases, such as hydrogen sulfide. In certain embodiments, the membranes can exhibit a H₂S:CO₂ selectivity of at least 5 (e.g., from 5 to 50) at 107° C. and 35 bar feed pressure. In certain embodiments, the membranes can exhibit an H₂S permeance of at least 300 GPU (e.g., from 300 GPU to 1000 GPU) at 107° C. and 35 bar feed pressure. In certain embodiments, the membranes can exhibit an CO₂ permeance of 200 GPU or less (e.g., 100 GPU or less) at 107° C. and 35 bar feed pressure.

Also provided are methods for separating H₂S gas from a feed gas stream comprising H₂S and CO₂ using the membranes described herein. These methods can include contacting a membrane described herein with the feed gas stream including the H₂S gas under conditions effective to afford transmembrane permeation of the H₂S gas. In some embodiments, the feed gas can comprise syngas or processed syngas. In some embodiments, the feed gas stream can have a temperature of at least 100° C. (e.g., at least 107° C., or a temperature of from greater than 100° C. to 180° C.). In some embodiments, the feed gas stream can have a pressure of at least 35 bar.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 shows a process for H₂ purification using CO₂-selective membranes in IGCC.

FIG. 2 shows the location the proposed membrane technology in an IGCC plant.

FIG. 3 is a schematic illustration of a membrane process for integration in IGCC (EX=turbo expander; HX=heat exchanger; MB=membrane; MSC=multi-stage compressor).

FIG. 4 is a schematic illustration showing the setup of continuous membrane column MB-02 for selective H₂S removal.

FIG. 5 is a plot showing the effect of H₂S/CO₂ selectivity on cost of electricity (COE) increase. The star marker denotes the COE increase based on the H₂S/CO₂ separation performance of the membrane containing potassium N-(1,1-dimethyl-2-hydroxyethyl)-aminoisobutyrate (tB-AIBA) as described in the examples.

FIG. 6 is a scheme showing the synthesis of N-isopropylglycine. Here, R refers to an isopropyl group.

FIG. 7 is a scheme showing the synthesis of N-(1,1-dimethyl-2-hydroxyethyl)-aminoisobutyric acid.

FIG. 8 is a scheme showing the crosslinking of poly(vinylalcohol).

FIG. 9 is a schematic of the mixed gas permeation test unit used in the examples (MFC: mass flow controller, GC: gas chromatograph).

FIG. 10 shows the structure of four carriers used in the examples.

FIG. 11 is a plot showing H₂S permeances and H₂S/CO₂ selectivities at 60 wt. % carrier loading.

FIG. 12 is a plot showing H₂S permeances and H₂S/CO₂ selectivities at 70 wt. % carrier loading.

FIG. 13 shows the structure of the potassium N,N-dimethylglycinate carrier.

FIG. 14 shows the structure of the N-(1,1-dimethyl-2-hydroxyethyl)-aminoisobutyric carrier (tB-AIBA).

FIGS. 15A and 15B show the H₂S permeance (FIG. 15A) and H₂S/CO₂ selectivity (FIG. 15B) at different feed H₂S contents.

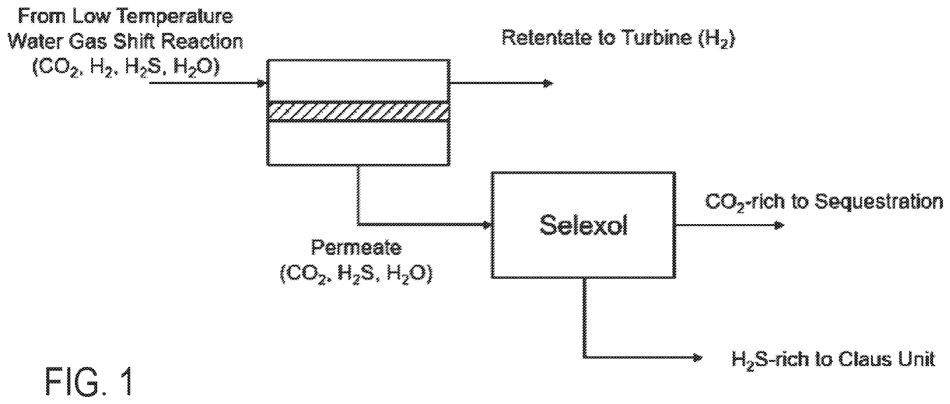

### DETAILED DESCRIPTION

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

A “control” is an alternative subject or sample used in an experiment for comparison purposes. A control can be “positive” or “negative.”

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

As used herein, “alkyl” means a straight or branched chain saturated hydrocarbon moieties such as those containing from 1 to 10 carbon atoms. A “higher alkyl” refers to saturated hydrocarbon having 11 or more carbon atoms. A “C₆-C₁₆” refers to an alkyl containing 6 to 16 carbon atoms. Likewise, a “C₆-C₂₂” refers to an alkyl containing 6 to 22 carbon atoms. Representative saturated straight chain alkyls include methyl, ethyl, n-propyl, n-butyl, n-pentyl, n-hexyl, n-septyl, n-octyl, n-nonyl, and the like; while saturated branched alkyls include isopropyl, sec-butyl, isobutyl, tert-butyl, isopentyl, and the like.

As used herein, the term “alkenyl” refers to unsaturated, straight or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond.

Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure-CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C.

As used herein, the term “alkynyl” represents straight or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended.

Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl.

Non-aromatic mono or polycyclic alkyls are referred to herein as “carbocycles” or “carbocyclyl” groups. Representative saturated carbocycles include cyclopropyl, cyclobutyl, cyclopentyl, cyclohexyl, and the like; while unsaturated carbocycles include cyclopentenyl and cyclohexenyl, and the like.

“Heterocarbocycles” or “heterocarbocyclyl” groups are carbocycles which contain from 1 to 4 heteroatoms independently selected from nitrogen, oxygen and sulfur which can be saturated or unsaturated (but not aromatic), monocyclic or polycyclic, and wherein the nitrogen and sulfur heteroatoms can be optionally oxidized, and the nitrogen heteroatom can be optionally quaternized. Heterocarbocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

The term “aryl” refers to aromatic homocyclic (i.e., hydrocarbon) mono-, bi- or tricyclic ring-containing groups preferably having 6 to 12 members such as phenyl, naphthyl and biphenyl. Phenyl is a preferred aryl group. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and, the like, where optionally one or more pair of substituents together with the atoms to which they are bonded form a 3 to 7 member ring.

As used herein, “heteroaryl” or “heteroaromatic” refers an aromatic heterocarbocycle having 1 to 4 heteroatoms selected from nitrogen, oxygen and sulfur, and containing at least 1 carbon atom, including both mono- and polycyclic ring systems. Polycyclic ring systems can, but are not required to, contain one or more non-aromatic rings, as long as one of the rings is aromatic. Representative heteroaryls are furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl, and quinazolinyl. It is contemplated that the use of the term “heteroaryl” includes N-alkylated derivatives such as a 1-methylimidazol-5-yl substituent.

As used herein, “heterocycle” or “heterocyclyl” refers to mono- and polycyclic ring systems having 1 to 4 heteroatoms selected from nitrogen, oxygen and sulfur, and containing at least 1 carbon atom. The mono- and polycyclic ring systems can be aromatic, non-aromatic or mixtures of aromatic and non-aromatic rings. Heterocycle includes heterocarbocycles, heteroaryls, and the like.

“Alkylthio” refers to an alkyl group as defined above with the indicated number of carbon atoms attached through a sulfur bridge. An example of an alkylthio is methylthio, (i.e., —S—CH₃).

“Alkoxy” refers to an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. Preferred alkoxy groups are methoxy, ethoxy, n-propoxy, i-propoxy, n-butoxy, s-butoxy, t-butoxy.

“Alkylamino” refers an alkyl group as defined above with the indicated number of carbon atoms attached through an amino bridge. An example of an alkylamino is methylamino, (i.e., —NH—CH₃).

“Alkanoyl” refers to an alkyl as defined above with the indicated number of carbon atoms attached through a carbonyl bride (i.e., —(C═O)alkyl).

“Alkylsulfonyl” refers to an alkyl as defined above with the indicated number of carbon atoms attached through a sulfonyl bridge (i.e., —S(═O)₂alkyl) such as mesyl and the like, and “Arylsulfonyl” refers to an aryl attached through a sulfonyl bridge (i.e., —S(═O)₂aryl).

“Alkylsulfamoyl” refers to an alkyl as defined above with the indicated number of carbon atoms attached through a sulfamoyl bridge (i.e., —NHS(═O)₂alkyl), and an “Arylsulfamoyl” refers to an alkyl attached through a sulfamoyl bridge (i.e., —NHS(═O)₂aryl).

“Alkylsulfinyl” refers to an alkyl as defined above with the indicated number of carbon atoms attached through a sulfinyl bridge (i.e. —S(═O)alkyl).

The terms “cycloalkyl” and “cycloalkenyl” refer to mono-, bi-, or tri homocyclic ring groups of 3 to 15 carbon atoms which are, respectively, fully saturated and partially unsaturated. The term “cycloalkenyl” includes bi- and tricyclic ring systems that are not aromatic as a whole, but contain aromatic portions (e.g., fluorene, tetrahydronapthalene, dihydroindene, and the like). The rings of multi-ring cycloalkyl groups can be either fused, bridged and/or joined through one or more spiro unions. The terms “substituted cycloalkyl” and “substituted cycloalkenyl” refer, respectively, to cycloalkyl and cycloalkenyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally substituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like.

The terms “halogen” and “halo” refer to fluorine, chlorine, bromine, and iodine.

The term “substituted” refers to a molecule wherein at least one hydrogen atom is replaced with a substituent. When substituted, one or more of the groups are “substituents.” The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)R^{a}, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

Reference will now be made in detail to specific aspects of the disclosed materials, compounds, compositions, articles, and methods, examples of which are illustrated in the accompanying Examples and Figures.

### Membranes

Membranes, methods of making the membranes, and methods of using the membranes are described herein. The membranes can comprise a gas permeable support layer, and a selective polymer layer disposed on the gas permeable support layer. The gas permeable support layer and the selective polymer layer can optionally comprise one or more sub-layers.

In some embodiments, the membrane can have an H₂S:CO₂ selectivity of at least 5 at 107° C. and 35 bar feed pressure. For example, the membrane can have a H₂S:CO₂ selectivity of at least 5 (e.g., at least 10, at least 15, at least 20, or at least 25) at 107° C. and 31.7 bar feed pressure. In some embodiments, the membrane can have a H₂S:CO₂ selectivity of 30 or less (e.g., 25 or less, 20 or less, 15 or less, or 10 or less) at 107° C. and 35 bar feed pressure.

In certain embodiments, the membrane can have a H₂S:CO₂ selectivity ranging from any of the minimum values described above to any of the maximum values described above. For example, in certain embodiments, the membrane can have a H₂S:CO₂ selectivity of from 5 to 30 at 107° C. and 35 bar feed pressure (e.g., from 5 to 25 at 107° C. and 35 bar feed pressure). The H₂S:CO₂ selectivity of the membrane can be measured using standard methods for measuring gas permeance known in the art, such as those described in the examples below.

In some embodiments, the membrane can have a H₂S permeance of at least 300 GPU (e.g., 350 GPU or greater, 400 GPU or greater, 450 GPU or greater, 500 GPU or greater, 550 GPU or greater, 600 GPU or greater, 650 GPU or greater, 700 GPU or greater, 750 GPU or greater, 800 GPU or greater, 850 GPU or greater, 900 GPU or greater, or 950 GPU or greater) at 107° C. and 35 bar feed pressure.

In some embodiments, the membrane can have a H₂S permeance of 1000 GPU or less at 107° C. and 35 bar feed pressure (e.g., 950 GPU or less, 900 GPU or less, 850 GPU or less, 800 GPU or less, 750 GPU or less, 700 GPU or less, 650 GPU or less, 600 GPU or less, 550 GPU or less, 500 GPU or less, 450 GPU or less, 400 GPU or less, or 350 GPU or less).

The H₂S permeance through the membrane can vary from any of the minimum values described above to any of the maximum values described above. For example, in some embodiments, the membrane can have a H₂S permeance of from 300 GPU to 100 GPU at 107° C. and 35 bar feed pressure (e.g., from 300 GPU to 800 GPU, from 300 GPU to 750 GPU, from 300 GPU to 800 GPU, or from 400 GPU to 750 GPU).

In some embodiments, the membrane can have a H₂S permeance of 200 GPU or less at 107° C. and 35 bar feed pressure (e.g., 175 GPU or less, 150 GPU or less, 125 GPU or less, 100 GPU or less, 75 GPU or less, or 50 GPU or less).

In some embodiments, the membrane can exhibit a ratio of H₂S permeance:CO₂ permeance of at least 5:1 (e.g., at least 10:1, at least 15:1, at least 20:1, or at least 25:1).

### Gas Permeable Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-iso-propylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In certain embodiments, the support layer can comprise a gas permeable polymer disposed on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

### Selective Polymer Layer

The selective polymer layer can include a selective polymer matrix. The selective polymer matrix can include a hydrophilic polymer, an amine-containing polymer (i.e., a fixed carrier), a mobile carrier (e.g., a sterically hindered amine or a salt thereof), a cross-linking agent, or a combination thereof.

In other embodiments, the selective polymer matrix can include a combination of a hydrophilic polymer, cross-linking agent, and a mobile carrier (e.g., a sterically hindered amine or a salt thereof). In some embodiments, selective polymer matrix can include a hydrophilic polymer, a cross-linking agent, a mobile carrier (e.g., a sterically hindered amine or a salt thereof), and an amine-containing polymer. In some embodiments, the hydrophilic polymer (e.g., polyvinyl alcohol) is crosslinked.

In some embodiments, the selective polymer layer can be a selective polymer matrix through which gas permeates via diffusion or facilitated diffusion.

### Cross-Linking Agents

The selective polymer matrix can include a cross-linking agent. Cross-linking agents suitable for use in the selective polymer matrix can include, but are not limited to, aminosilane, formaldehyde, glutaraldehyde, maleic anhydride, glyoxal, divinylsulfone, toluenediisocyanate, trimethylol melamine, terephthalatealdehyde, epichlorohydrin, or vinyl acrylate, and combinations thereof.

In some embodiments, the cross-linking agent can include aminosilane. In some embodiments, the cross-linking agent can include aminosilane and glyoxal. The selective polymer matrix can include any suitable amount of the cross-linking agent. For example, the selective polymer matrix can comprise 1 to 70 percent cross-linking agents by weight of the selective polymer matrix. In some embodiments, the cross-linking agent can be at least 30%, at least 35%, at least 40% or at least 50%. In some embodiments, the cross-linking agent can be 40% aminosilane and 20% glyoxal by weight of the selective polymer matrix. In some embodiments, the cross-linking agent can be 35% aminosilane and 25% glyoxal by weight of the selective polymer matrix.

In some cases, the cross-linking agent can be an aminosilane tetravalent single bonded Si with at least one substituent containing an amino group(s) defined by formula I below

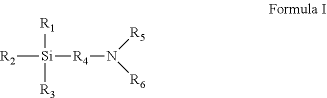

wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, or substituted or unsubstituted alkyl;
wherein at least one R₁, R₂ or R₃ is a substituted or unsubstituted alkoxy.

### Hydrophilic Polymers

The selective polymer matrix can include any suitable hydrophilic polymer. In some embodiments, the hydrophilic polymer is crosslinked with an aminosilane defined by Formula I. Examples of hydrophilic polymers suitable for use in the selective polymer layer can include polyvinylalcohol, polyvinylacetate, polyethylene oxide, polyvinylpyrrolidone, polyacrylamine, a polyamine such as polyallylamine, polyvinyl amine, or polyethylenimine, copolymers thereof, and blends thereof. In some embodiments, the hydrophilic polymer includes polyvinylalcohol.

The selective polymer matrix can include any suitable crosslinked hydrophilic polymer (e.g., aminosilane crosslinked polyvinyl alcohol).

When present, the hydrophilic polymer can have any suitable molecular weight. For example, the hydrophilic polymer can have a weight average molecular weight of from 15,000 Da to 2,000,000 Da (e.g., from 50,000 Da to 200,000 Da). In some embodiments, the hydrophilic polymer can include polyvinyl alcohol having a weight average molecular weight of from 50,000 Da to 150,000 Da. In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can include any suitable amount of the hydrophilic polymer. For example, in some cases, the selective polymer layer can include from 10% to 90% by weight (e.g., from 10% to 50% by weight, or from 10% to 30% by weight) hydrophilic polymer, based on the total weight of the components used to form the selective polymer layer.

When present, the crosslinked hydrophilic polymer can have any suitable molecular weight. For example, the crosslinked hydrophilic polymer can have a weight average molecular weight of from 15,000 Da to 2,000,000 Da (e.g., from 50,000 Da to 200,000 Da). In some embodiments, the crosslinked hydrophilic polymer can include aminosilane crosslinked polyvinyl alcohol having a weight average molecular weight of from 50,000 Da to 150,000 Da. In other embodiments, the crosslinked hydrophilic polymer can be a high molecular weight crosslinked hydrophilic polymer. For example, the crosslinked hydrophilic polymer can have a weight average molecular weight of at least 500,000 Da (e.g., at least 700,000 Da, or at least 1,000,000 Da).

The selective polymer layer can include any suitable amount of the crosslinked hydrophilic polymer. For example, in some cases, the selective polymer layer can include from 10% to 90% by weight (e.g., from 10% to 50% by weight, or from 10% to 30% by weight) crosslinked hydrophilic polymer, based on the total weight of the components used to form the selective polymer layer.

### Mobile Carriers

The selective polymer matrix can comprise a mobile carrier comprising a sterically hindered amine or a salt thereof.

In some embodiments, the mobile carrier (i.e., the alkanolamine or a salt thereof) can have a molecular weight of less than 1,000 Da (e.g., 800 Da or less, 500 or less, 300 Da or less, or 250 Da or less). In some embodiments, the mobile carrier can be non-volatile at the temperatures at which the membrane will be stored or used.

In some embodiments, the mobile carrier comprises a compound defined by the structure below:

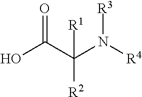

or a salt thereof, wherein
R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R¹ can be selected from alkyl, alkenyl, alkynyl, cycloalkyl, heterocycloalkyl, aryl, and heteroaryl, each optionally substituted with one or more substituents individually chosen from R^{a}. In certain embodiments, R¹ and R² are each independently selected from alkyl, alkenyl, alkynyl, cycloalkyl, heterocycloalkyl, aryl, and heteroaryl, each optionally substituted with one or more substituents individually chosen from R^{a}.

In some embodiments, R³ is hydrogen. In other embodiments, R³ and R⁴ are each independently selected from alkyl, alkenyl, alkynyl, cycloalkyl, heterocycloalkyl, aryl, and heteroaryl, each optionally substituted with one or more substituents individually chosen from R^{a}.

In some embodiments, the mobile carrier comprises a compound defined by the structure below:

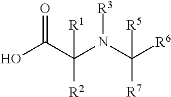

or a salt thereof, wherein
R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁵ and R⁶ are independently selected from hydrogen, alkyl, alkenyl, alkynyl, cycloalkyl, heterocycloalkyl, aryl, and heteroaryl, each optionally substituted with one or more substituents individually chosen from R^{a};
R⁷ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R¹ can be selected from alkyl, alkenyl, alkynyl, cycloalkyl, heterocycloalkyl, aryl, and heteroaryl, each optionally substituted with one or more substituents individually chosen from R^{a}. In certain embodiments, R¹ and R² are each independently selected from alkyl, alkenyl, alkynyl, cycloalkyl, heterocycloalkyl, aryl, and heteroaryl, each optionally substituted with one or more substituents individually chosen from R^{a}.

In some embodiments, R³ is hydrogen. In other embodiments, R³ is selected from alkyl, alkenyl, alkynyl, cycloalkyl, heterocycloalkyl, aryl, and heteroaryl, each optionally substituted with one or more substituents individually chosen from R^{a}.

In some embodiments, R⁵ can be selected from alkyl, alkenyl, alkynyl, cycloalkyl, heterocycloalkyl, aryl, and heteroaryl, each optionally substituted with one or more substituents individually chosen from R^{a}. In certain embodiments, R⁵ and R⁶ are each independently selected from alkyl, alkenyl, alkynyl, cycloalkyl, heterocycloalkyl, aryl, and heteroaryl, each optionally substituted with one or more substituents individually chosen from R^{a}.

In some embodiments, the mobile carrier comprises a compound defined by the structure below:

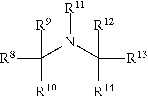

or a salt thereof, wherein
R¹ and R⁹ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁰ is selected from alkyl, alkenyl, alkynyl, cycloalkyl, heterocycloalkyl, aryl, and heteroaryl, each optionally substituted with one or more substituents individually chosen from R^{a};
R¹¹ is selected from hydrogen, alkyl, alkenyl, alkynyl, cycloalkyl, heterocycloalkyl, aryl, and heteroaryl, each optionally substituted with one or more substituents individually chosen from R^{a};
R¹² and R¹³ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

In some embodiments, R⁸ can be selected from alkyl, alkenyl, alkynyl, cycloalkyl, heterocycloalkyl, aryl, and heteroaryl, each optionally substituted with one or more substituents individually chosen from R^{a}. In certain embodiments, R¹ and R⁹ are each independently selected from alkyl, alkenyl, alkynyl, cycloalkyl, heterocycloalkyl, aryl, and heteroaryl, each optionally substituted with one or more substituents individually chosen from R^{a}.

In some embodiments, R¹¹ is hydrogen. In other embodiments, R¹¹ is selected from alkyl, alkenyl, alkynyl, cycloalkyl, heterocycloalkyl, aryl, and heteroaryl, each optionally substituted with one or more substituents individually chosen from R^{a}.

In some embodiments, R¹² can be selected from alkyl, alkenyl, alkynyl, cycloalkyl, heterocycloalkyl, aryl, and heteroaryl, each optionally substituted with one or more substituents individually chosen from R^{a}. In certain embodiments, R¹² and R¹³ are each independently selected from alkyl, alkenyl, alkynyl, cycloalkyl, heterocycloalkyl, aryl, and heteroaryl, each optionally substituted with one or more substituents individually chosen from R^{a}.

In some examples, the mobile carrier can be one of the following

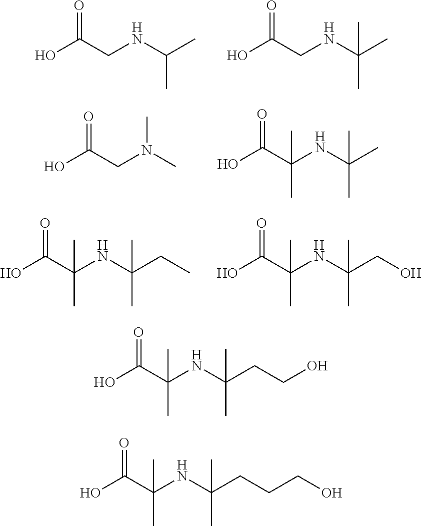

### Amine-Containing Polymers

Optionally, the selective polymer matrix can include an amine-containing polymer.

In some embodiments, the amine-containing polymer can include one or more primary amine moieties and/or one or more secondary amine moieties. In these embodiments, the amine-containing polymer can serve as a “fixed-site carrier” and the low molecular weight amino compound can serve as a “mobile carrier.”

In some embodiments, the amino compound comprises an amine-containing polymer (also referred to herein as a “fixed-site carrier”). The amine-containing polymer can have any suitable molecular weight. For example, the amine-containing polymer can have a weight average molecular weight of from 5,000 Da to 5,000,000 Da, or from 50,000 Da to 2,000,000 Da. Suitable examples of amine-containing polymers include, but are not limited to, polyvinylamine, polyallylamine, polyethyleneimine, poly-N-methylvinylamine, poly-N-ethylvinylamine, poly-N-propylvinylamine, poly-N-isopropylvinylamine, poly-N-isobutylvinylamine, poly-N-tert-butylvinylamine, poly-N,N-dimethylvinylamine, poly-N,N-diethylvinylamine, poly-N-isopropylallylamine, poly-N-isobutylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In some embodiments, the amine-containing polymer can comprise polyvinylamine (e.g., polyvinylamine having a weight average molecular weight of from 50,000 Da to 2,000,000 Da). In some embodiments when the amino compound comprises an amine-containing polymer, the selective polymer layer can comprise a blend of an amine-containing polymer and a hydrophilic polymer (e.g., an amine-containing polymer dispersed in a hydrophilic polymer matrix).

### Graphene Oxide

In some embodiments, the selective polymer matrix can further include graphene oxide.

The term “graphene” refers to a one-atom-thick planar sheet of sp2-bonded carbon atoms that are densely packed in a honeycomb crystal lattice. In one embodiment, it refers to a single-layer version of graphite.

The term “graphene oxide” herein refers to functionalized graphene sheets (FGS) the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g. approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “m”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g., “GO(2)” refers to graphene oxide with a C:O ratio of 2.

In some embodiments, the graphene oxide can be GO((m). In some embodiments, the graphene oxide can be GO(L). In some embodiments, the graphene oxide can be nanoporous.

### Other Components

In some embodiments, the selective polymer matrix can further include a base. The base can act as a catalyst to catalyze the cross-linking of the selective polymer matrix (e.g., cross-linking of a hydrophilic polymer with an amine-containing polymer). In some embodiments, the base can remain in the selective polymer matrix and constitute a part of the selective polymer matrix. Examples of suitable bases include potassium hydroxide, sodium hydroxide, lithium hydroxide, triethylamine, N,N-dimethylamninopyridine, hexamethyltriethylenetetraamine, potassium carbonate, sodium carbonate, lithium carbonate, and combinations thereof. In some embodiments, the base can include potassium hydroxide. The selective polymer matrix can comprise any suitable amount of the base. For example, the selective polymer matrix can comprise 1 to 40 percent base by weight of the selective polymer matrix.

The selective polymer matrix can further comprise carbon nanotubes dispersed within the selective polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of a least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above. For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then be coupled to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer matrix can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer matrix. In some embodiments, the selective polymer matrix can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer matrix.

The selective matrix layer can comprise an amount of carbon nanotubes ranging from any of the minimum values described above to any of the maximum values described above. For example, the selective polymer matrix can comprise from 0.5% to 5% (e.g., from 1% to 3%) by weight carbon nanotubes, based on the total dry weight of the selective polymer matrix.

If desired, the selective polymer matrix can be surface modified by, for example, chemical grafting, blending, or coating to improve the performance of the selective polymer matrix. For example, hydrophobic components may be added to the selective polymer matrix to alter the properties of the selective polymer matrix in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 25 microns (e.g., from 100 nanometers to 750 nanometers, from 250 nanometers to 500 nanometers, from 50 nm to 2 microns, from 50 nm to 20 microns, or from 1 micron to 20 microns). In some embodiments, the support layer can have a thickness of from 1 micron to 500 microns (e.g., from 50 to 250 microns). In some cases, the membranes disclosed herein can have a thickness of from 5 microns to 500 microns.

### Methods of Making

Methods of making these membranes are also disclosed herein. Methods of making membranes can include depositing a selective polymer layer on a support layer to form a selective layer disposed on the support layer. The selective polymer layer can comprise a selective polymer matrix.

Optionally, the support layer can be pretreated prior to deposition of the selective polymer layer, for example, to remove water or other adsorbed species using methods appropriate to the support and the adsorbate. Examples of absorbed species are, for example, water, alcohols, porogens, and surfactant templates.

The selective polymer layer can be prepared by first forming a coating solution including the components of the selective polymer matrix (e.g., a hydrophilic polymer, a cross-linking agent, a mobile carrier, an amine-containing polymer, or a combination thereof, and optionally a basic compound and/or graphene oxide in a suitable solvent). One example of a suitable solvent is water. In some embodiments, the amount of water employed will be in the range of from 50% to 99%, by weight of the coating solution. The coating solution can then be used in forming the selective polymer layer. For example, the coating solution can be coated onto a support later (e.g., a nanoporous gas permeable membrane) using any suitable technique, and the solvent may be evaporated such that a nonporous membrane is formed on the substrate. Examples of suitable coating techniques include, but are not limited to, “knife coating” or “dip coating”. Knife coating include a process in which a knife is used to draw a polymer solution across a flat substrate to form a thin film of a polymer solution of uniform thickness after which the solvent of the polymer solution is evaporated, at ambient temperatures or temperatures up to about 100° C. or higher, to yield a fabricated membrane. Dip coating include a process in which a polymer solution is contacted with a porous support. Excess solution is permitted to drain from the support, and the solvent of the polymer solution is evaporated at ambient or elevated temperatures. The membranes disclosed can be shaped in the form of hollow fibers, tubes, films, sheets, etc. In certain embodiments, the membrane can be configured in a flat sheet, a spiral-wound, a hollow fiber, or a plate-and-frame configuration.

In some embodiments, membranes formed from a selective polymer matrix containing for example, a hydrophilic polymer, a cross-linking agent, and a mobile carrier can be heated at a temperature and for a time sufficient for cross-linking to occur. In one example, cross-linking temperatures in the range from 80° C. to 100° C. can be employed. In another example, cross-linking can occur from 1 to 72 hours. The resulting solution can be coated onto the support layer and the solvent evaporated, as discussed above. In some embodiments, a higher degree of cross-linking for the selective polymer matrix after solvent removal takes place at about 100° C. to about 180° C., and the cross-linking occurs in from about 1 to about 72 hours.

An additive may be included in the selective polymer layer before forming the selective polymer layer to increase the water retention ability of the membrane. Suitable additives include, but are not limited to, polystyrenesulfonic acid-potassium salt, polystyrenesulfonic acid-sodium salt, polystyrenesulfonic acid-lithium salt, sulfonated polyphenyleneoxides, alum, and combinations thereof. In one example, the additive comprises polystyrenesulfonic acid-potassium salt.

In some embodiments, the method of making these membranes can be scaled to industrial levels.

### Methods of Use

The membranes disclosed herein can be used for separating gaseous mixtures.

For example, provided are methods for separating H₂S gas from a feed gas stream comprising H₂S and CO₂ using the membranes described herein. These methods can include contacting a membrane described herein (e.g., on the side comprising the selective polymer) with the feed gas stream including the H₂S gas under conditions effective to afford transmembrane permeation of the H₂S gas.

In some embodiments, the method can also include withdrawing from the reverse side of the membrane a permeate containing at least the H₂S gas, wherein the H₂S gas is selectively removed from the gaseous stream. The permeate can comprise at least the H₂S gas in an increased concentration relative to the feed stream. The term “permeate” refers to a portion of the feed stream which is withdrawn at the reverse or second side of the membrane, exclusive of other fluids such as a sweep gas or liquid which may be present at the second side of the membrane.

The membrane can be used to separate fluids at any suitable temperature, including temperatures of 100° C. or greater. For example, the membrane can be used at temperatures of from 100° C. to 180° C. In some embodiments, the first gas stream can have a temperature of at least 107° C. In some embodiments, a vacuum can be applied to the permeate face of the membrane to remove the H₂S gas. In some embodiments, a sweep gas can be flowed across the permeate face of the membrane to remove the H₂S gas. Any suitable sweep gas can be used. Examples of suitable sweep gases include, for example, air, steam, nitrogen, argon, helium, and combinations thereof.

In certain embodiments, the feed gas comprises syngas or processed syngas.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

By way of non-limiting illustration, examples of certain embodiments of the present disclosure are given below.

### EXAMPLES

### Overview

This example describes the use of sterically hindered secondary and tertiary amine carriers in facilitated transport membranes to achieve high H₂S/CO₂ selectivity at elevated temperatures (>100° C.) for H₂S removal from H₂S—CO₂ mixtures separated from their gas sources, including coal- and/or natural gas-derived syngas, biomass-derived syngas, tail gas from sulfur plants, and biogas. This H₂S removal allows for the capture of high-purity CO₂ from the H₂S—CO₂ mixtures for enhanced oil recovery or sequestration. The captured H₂S may be sent to a sulfur plant using the Claus process for sulfur production. In the membranes, the selective layer consists of a sterically hindered amino acid salt in a poly(vinylalcohol) matrix, and it is coated onto a nanoporous support. The example demonstrates that the steric hindrance effect of amines can be applied in facilitated transport membranes to inhibit the transport of CO₂ without affecting the transport of H₂S, leading to high H₂S/CO₂ selectivity.

### Background

Selective H₂S/CO₂ separation has been achieved in absorption using sterically hindered amines and tertiary amines. The CO₂-amine reaction proceeds via nucleophilic attack, which is retarded by the steric hindrance of amine, while the H₂S-amine reaction is a proton transfer reaction, independent of the amine steric hindrance [6, 7]. The use of highly hindered amines reduces the rate of the amine-CO₂ reaction without affecting the H₂S-amine reaction. Accordingly, hindered amino alcohols such as 2-amino-2-methyl-1-propanol and tertiary amino alcohols such as N-methyldiethanolamine showed higher H₂S/CO₂ selectivity compared to unhindered amino alcohols such as monoethanolamine [8-13]. Hindered amino ethers and aminoacids were also shown to be useful for selective H₂S removal from CO₂ [12, 14]. In this example, we demonstrate that this amine hindrance effect also extends to facilitated transport membranes.

This example describes the use of sterically hindered secondary and tertiary amine carriers in facilitated transport membranes to achieve high H₂S/CO₂ selectivity at elevated temperatures (>100° C.) for H₂S removal from H₂S—CO₂ mixtures separated from their gas sources, including coal- and/or natural gas-derived syngas (containing H₂S, CO₂, H₂, and H₂O), biomass-derived syngas (containing H₂S, CO₂, H₂, and H₂O), tail gas from sulfur plants (containing H₂S, CO₂, N₂, and H₂O), and biogas (containing H₂S, CO₂, CH₄, and H₂O). The separation of both acid gases of H₂S and CO₂ from these gas sources can be done through amine-containing facilitated transport membranes or aqueous amine scrubbing solutions. This H₂S removal allows for the capture of high-purity CO₂ from the H₂S—CO₂ mixtures for enhanced oil recovery or sequestration. The captured H₂S may be sent to a sulfur plant using the Claus process for sulfur production. In the membranes, the selective layer consists of a sterically hindered amino acid salt in a poly(vinylalcohol) matrix, and it is coated onto a nanoporous support. The examples demonstrate that the steric hindrance effect of amines can be applied in facilitated transport membranes to inhibit the transport of CO₂ without affecting the transport of H₂S, leading to high H₂S/CO₂ selectivity.

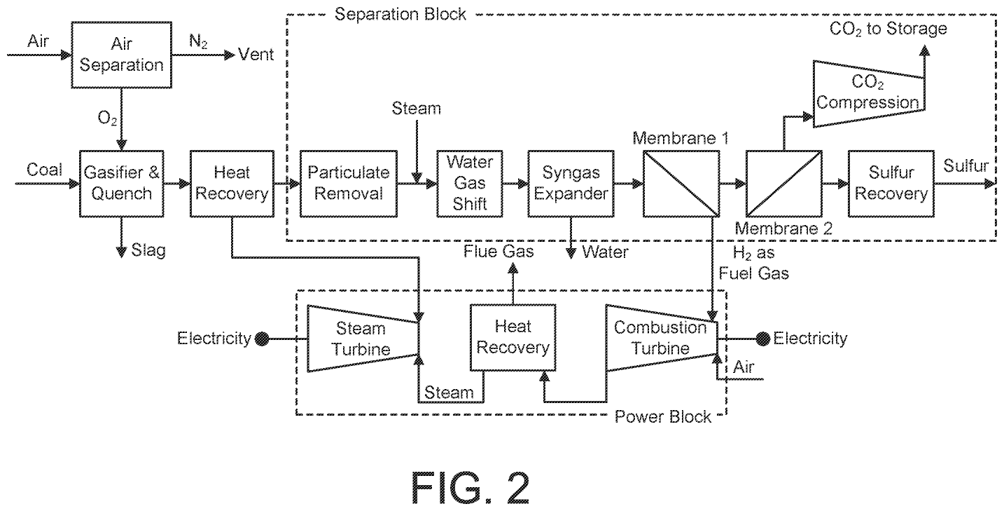

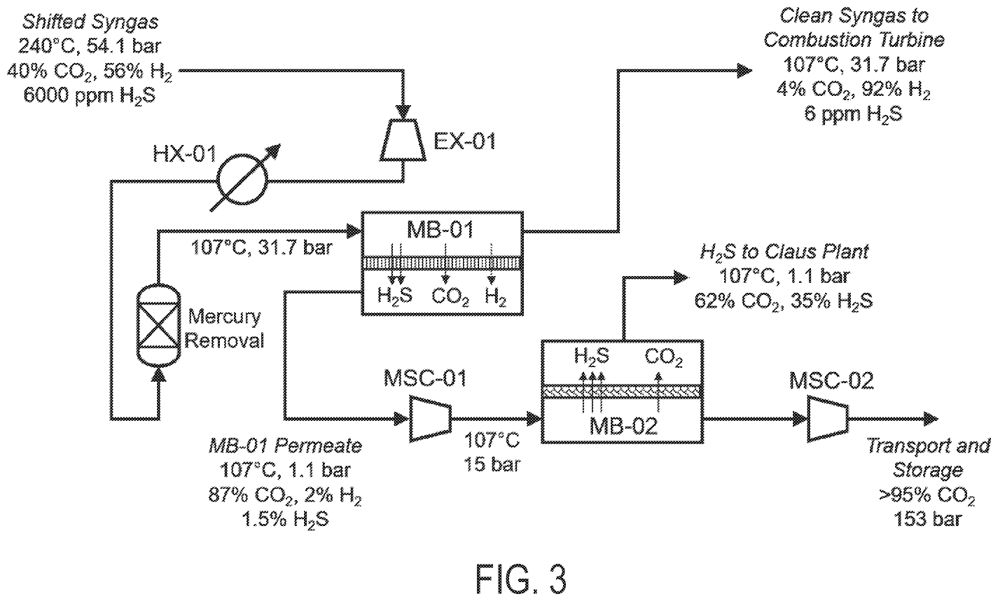

The usefulness of the membranes disclosed in these examples is exemplified by the H₂S removal from coal-derived syngas in an integrated gasification combined cycle (IGCC). The location of the membrane process in the IGCC plant is shown in FIG. 2. A detailed process flow diagram of the single-stage membrane process is shown in FIG. 3. Cases B5A and B5B in the 2015 Cost and Performance Baseline of the U.S. Department of Energy [15] are followed for the IGCC with the “radiant-only” gasifier of General Electric Energy (GEE). The high pressure shifted syngas (54.1 bar) from the low temperature water-gas-shift reactor is expanded to 31.7 bar by a turboexpander EX-01. The thermal expansion cools the gas stream for mercury removal by an activated, sulfur-impregnated carbon adsorption bed. The treated syngas is further cooled by a heat exchanger HX-01 to 107° C.

The conditioned syngas enters the first membrane stage MB-01 with a CO₂/H₂ selectivity>100, which separates the feed to a CO₂-depleted retentate with 90% CO₂ removal and 99.4% H₂ recovery, and a CO₂-rich permeate with >95% CO₂ purity on dry basis. Due to the decent H₂S/CO₂ selectivity of >3, H₂S also permeates to the downstream preferentially, resulting in 6 ppm H₂S in the retentate. The retentate (4% CO₂, 92% H₂, and 6 ppm H₂S with balance of water) is sent to the gas turbine combustor for power generation. The permeate side of MB-01 is operated at 1.1 bar to maximize the transmembrane driving force without incurring extra parasitic energy, which results in a gas stream of 87% CO₂, 2% H₂, and 1.5% H₂S with balance of water vapor [16].

In order to remove the H₂S from the captured CO₂, the permeate of MB-01 (1.5% H₂S) is compressed to 15 bar by a multi-stage compressor (3-stage front-loaded centrifugal), MSC-01, and sent to the second membrane stage MB-02 unit for H₂S removal. This stage utilizes the membranes disclosed in this invention with H₂S/CO₂ selectivities greater than 10. The recovered H₂S (35% H₂S) is further converted to elemental sulfur by a Claus plant. The H₂S-stripped CO₂ stream is eventually compressed to 153 bar by a 3-stage front-loaded centrifugal compressor MSC-02 for transport and storage or enhanced oil recovery.

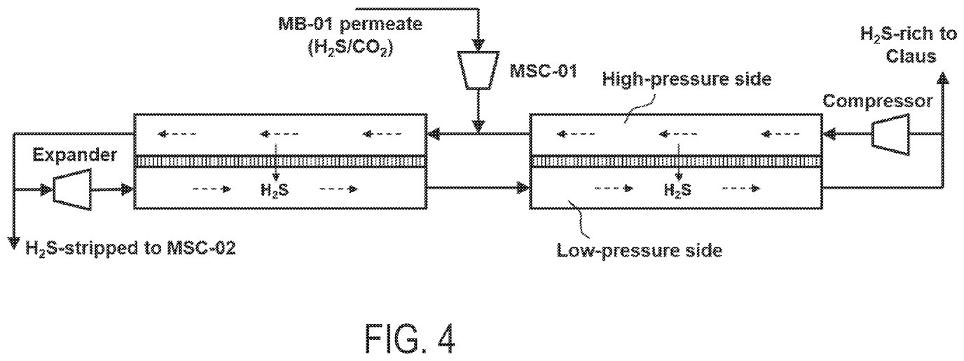

Special attention should be paid to the second membrane stage MB-02. In order to enrich the H₂S from 1.5% (as in MB-01 permeate) to 35% (as for the Claus process), MB-02 is operated as a continuous membrane column, which is shown schematically in FIG. 4. As seen, MB-02 is split into two substages in-series. The permeate gas of MB-01 is compressed by MSC-01 to 15 bar and sent to the interconnection of the two substages. The H₂S permeates from the high-pressure to the low-pressure side. The majority of the H₂S-stripped, pressurized CO₂ is sent to MSC-02 for further compression; the remaining of it is expanded and recycled to the low-pressure side. Similarly, the majority of the H₂S-rich, low-pressure permeate is sent the Claus process for sulfur recovery; the remaining of it is recompressed and recycled to the high-pressure side. The two recycle streams enhance the transmembrane driving force for H₂S. Therefore, a high H₂S enrichment factor can be achieved with a practical H₂S/CO₂ selectivity.

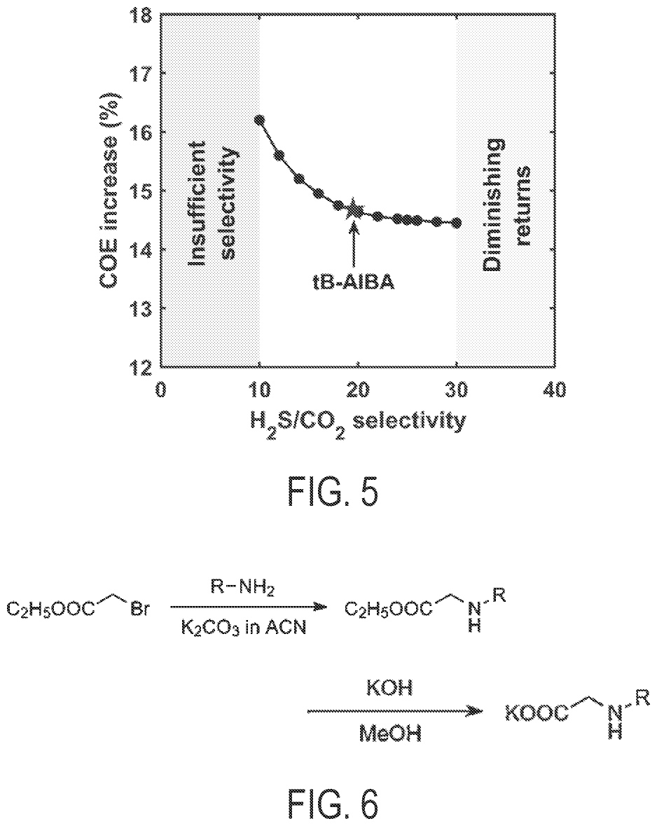

The continuous membrane column shown in FIG. 4 was modeled to calculate the required H₂S/CO₂ selectivity to enrich the H₂S from 1.5% to 35%. The process economics was also evaluated in terms of the increase in cost of electricity (COE), which is defined as the percentage increase of COE caused by the membrane process vs. the case without carbon capture (i.e., Case B5A in the Baseline document [15]). The feed and permeate pressures were fixed at 15 and 1.1 bar, respectively. As shown in FIG. 5, a minimum selectivity of 10 was required to achieve the separation specifications. A higher selectivity reduced the COE increase, with a minimum achieved at 20-25 selectivity. For the best membrane containing 70% potassium N-(1,1-dimethyl-2-hydroxyethyl)-aminoisobutyrate (tB-AIBA) as the mobile carrier (see Example 4 below), a low value of COE increase of 14.9% can be achieved.

The following is a general description of the materials and experimental methods utilized in the examples.

### Materials

Poly(vinylalcohol) (PVA) POVAL 100-88 (94%, 87-89% hydrolysis degree) was provided by Kuraray America. Glacial acetic acid (99%), potassium hydroxide (90%), glycine (99%), sarcosine (99%), N-tert-butylglycine hydrochloride (98%), sodium hydroxide and glutaraldehyde (50% in water) were purchased from Sigma Aldrich. Sodium chloride was purchased from Sigma Aldrich. N,N-Dimethylglycine (99%) was purchased from Alfa-Aesar. Acetonitrile (99%), chloroform (99%), ethyl bromoacetate (98%), and isopropylamine (98%) were purchased from VWR Chemicals. Deuterium oxide (99.9 atom % D, containing 0.05% wt. % 3-(trimethylsilyl)propionic-2,2,3,3-d₄ acid, sodium salt (NaTMSP)) was purchased from Sigma Aldrich. Methanol, acetone, potassium carbonate, and ethanol were purchased from Fisher Scientific. Purolite® A6000H strong base anion-exchange resin and Purolite® C100H acid cation-exchange resin were provided by Purolite Corporation. Nanoporous polysulfone with an average pore size of 10 nm and a porosity of about 7% was purchased from Microdyn-Nadir US Inc. The carbon dioxide and hydrogen sulfide used in the feed gases as well as the helium required for gas chromatography (GC) were purchased from Praxair, Inc.

In order to demonstrate the amine steric hindrance effect in facilitated transport membranes, hindered amine molecules were used as the carriers in the membranes. In these examples, aminoacid salts were chosen as the mobile carriers for nonvolatility. However, in principle, other classes of hindered amines can be utilized. In terms of the polymer matrix for the selective layer, it can be but not limited to polyvinylalcohol. In these examples, poly(vinylalcohol) from Kuraray America was crosslinked using glutaraldehyde and used as the polymer matrix. However, other water-soluble polymers with sufficient mechanical integrity under the conditions of interest can also be used.

### Syntheses of Amino Acid Carriers

In the syntheses, glycine, sarcosine, and dimethylglycine were used as received without further processing.

### Synthesis of N-tert-butylglycine

N-tert-butylglycine hydrochloride was dissolved in methanol to form a 5 wt. % solution. The hydrochloride was ion-exchanged out using Purolite® A6000H anion exchange resin, following which the resin was filtered out. The methanol was evaporated out under vacuum to obtain N-tert-butylglycine.

### Synthesis of N-isopropylglycine

N-isopropylglycine was synthesized using ethyl bromoacetate and isopropylamine, as shown in FIG. 6. 25 mmol ethyl bromoacetate (1 eq) and 50 mmol isopropylamine (2 eq) was added to 30 ml acetonitrile. K₂CO₃ (2 eq) was added dropwise as a 30 wt. % solution in water under stirring. The reaction mixture was stirred overnight at room temperature. After the reaction, the solution was extracted with ethyl acetate and water. The organic phase was washed with 10% NaCl twice. The organic phase was then collected and evaporated under vacuum to remove the ethyl acetate and collect the crude ester, ethyl N-isopropylglycinate. The ester was then dissolved in 20 ml of methanol along with 10 mmol KOH to hydrolyze the ester. The solution was stirred overnight at room temperature to complete the hydrolysis. The KOH was removed using Purolite® C100H cation exchange resin. The solution was then evaporated under vacuum to obtain an off-white solid product. The product was then washed with acetone and vacuum dried to obtain N-isopropylglycine. The purity was confirmed to be >95% via proton NMR.

### Synthesis of N-(1,1-dimethyl-2-hydroxyethyl)-aminoisobutyric acid

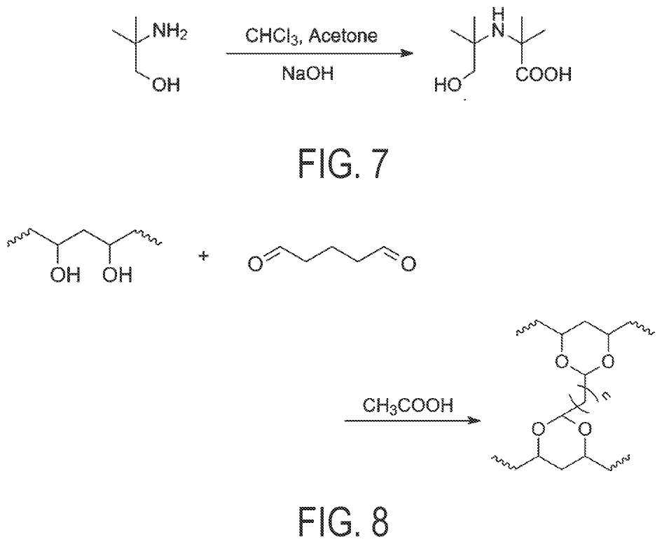

N-(1,1-dimethyl-2-hydroxyethyl)-aminoisobutyric acid was synthesized via the Bargellini reaction, shown in FIG. 7. 2-Amino-2-methylpropan-1-ol (30 mmol), chloroform (15 mmol) and acetone (100 mmol) were added to a round bottom flask under stirring with the temperature controlled at 0° C. with an ethanol-ice bath. Powdered sodium hydroxide (50 mmol) was added to the solution under nitrogen atmosphere in 5 portions while keeping the temperature below 5° C. The solution was stirred overnight. The slurry obtained was filtered under vacuum. The solid obtained was washed with 100 ml of methanol. The combined filtrate was ion-exchanged using the ion-exchange resin Purolite® C100H to remove the sodium hydroxide. The solution was then evaporated under vacuum to obtain an off-white solid residue. The solid residue was washed with acetone. The product thus obtained contained some inorganic impurities, which was removed by once again dissolving the solid in ethanol. The insoluble inorganic impurity was filtered off, and the soluble N-(1,1-dimethyl-2-hydroxyethyl)-aminoisobutyric acid product was obtained by evaporating the ethanol under vacuum. The purity was confirmed to be >95% using proton NMR.

### Crosslinking of Poly(Vinylalcohol)

PVA POVAL 100-88 was dissolved in water overnight to obtain a solution with 4 wt. % concentration. A drop of glacial acetic acid was added to catalyze the crosslinking. A calculated amount of glutaraldehyde was added for 100% crosslinking. The crosslinking was carried out at overnight at room temperature, and a significant change in the viscosity was observed after crosslinking. The reaction is described in FIG. 8. The acetic acid was removed using Purolite® A6000H strong base anion-exchange resin.

### Preparation of Coating Solution and Membrane Coating

The carrier solution was prepared by dissolving the amino acid carrier in water. In case of N-tert-butylglycine hydrochloride, ion exchange was carried out to remove the hydrochloride using Purolite® A6000H strong base anion exchange resin. A stoichiometric amount of potassium hydroxide was added to the solution under stirring to deprotonate the aminoacid.

The coating solution was prepared by adding the carrier solution dropwise to 4 wt. % crosslinked PVA under vigorous stirring. If required, the coating solution was purged under nitrogen to increase the solid content and viscosity. The solution was centrifuged at 3000 rpm for 5 minutes to remove any bubbles before coating. The solution was coated on to the nanoporous polysulfone support with a GARDCO adjustable micrometer film applicator (Paul N. Gardner Company), with the gap setting adjusted according to the selective layer thickness required. The membrane was dried in a fume hood for half an hour and then held at 120° C. in a muffle furnace for 6 hours to complete the crosslinking.

### Gas Permeation Measurements

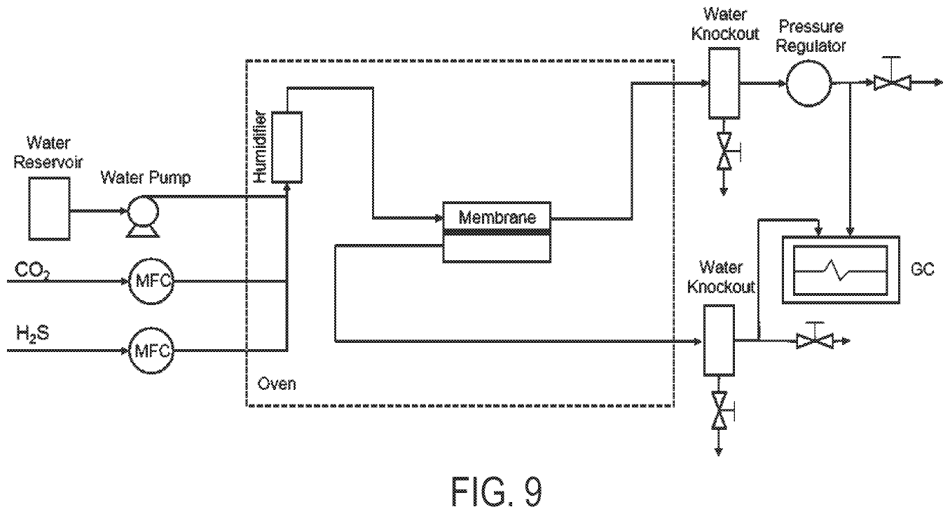

A Wicke-Kallenbach permeation apparatus, shown in FIG. 9, was used to measure the membrane transport properties. The membranes were tested at 107° C. with a dry feed gas composition of 98.5% CO₂ and 1.5% H₂S, similar to the acid gas stream following the syngas purification. The membrane was placed in the gas permeation cell for testing. The permeate pressure was maintained at 1 psig. After water removal in the knockout vessel, the CO₂ concentration was measured by a GC with a thermal conductivity detector (Model 6890 N, Agilent Technologies) and a stainless steel micropacked column (80/100 Hayesep-D, Sigma-Aldrich).

### Example 1—Group 1 Membranes

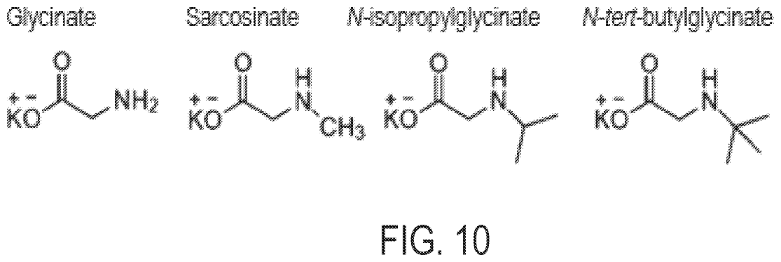

In this example, the potassium salts of glycine, sarcosine, N-isopropylglycine and N-tert-butylglycine (structures shown in FIG. 10), were incorporated as a mobile carrier into the membrane at 60 wt. % carrier loading. Here, glycine (Gly) is a primary amine, and sarcosine (Sar), N-isopropylglycine (iP-Gly), and N-tert-butylglycine (tB-Gly) are secondary amines; the degree of steric hindrance increases in the order. The membrane selective layer consisted of the crosslinked PVA and the potassium salt of the amino acid.

In order to prepare the coating solution containing 60% potassium glycinate, a 23 wt. % carrier solution of potassium glycinate was prepared by dissolving 0.87 grams of glycine in 5 grams of water. 0.71 grams of KOH was added to deprotonate the amino acid. Then, 0.88 grams of the potassium glycinate solution (19 wt. %) was added to 3.5 grams of 100% glutaraldehyde-crosslinked PVA (3.7 wt. %).

In order to prepare the coating solution containing 60% potassium sarcosinate, a 22 wt. % carrier solution of potassium sarcosinate was prepared by dissolving 1 grams of sarcosine in 6 grams of water. 0.75 grams of KOH was added to deprotonate the amino acid. Then, 1.06 grams of the potassium sarcosinate solution (22 wt. %) was added to 4 grams of 100% glutaraldehyde-crosslinked PVA (3.7 wt. %).

For preparing the coating solution containing 60% potassium N-isopropylglycinate, a 9 wt. % carrier solution was prepared by dissolving 0.3 grams of N-isopropylglycine in 4 grams of water. 0.15 grams of KOH was added to deprotonate the amino acid. Then, 1.7 grams of the potassium N-isopropylglycinate (9 wt. %) was added to 2.5 grams of 100% glutaraldehyde-crosslinked PVA (3.9 wt. %).

Similarly, for preparing the coating solution containing 60% potassium N-tert-butylglycinate, a 11 wt. % carrier solution of potassium N-tert-butylglycinate was prepared by dissolving 0.44 grams of N-tert-butylglycine in 5.1 grams of water. 0.2 grams of KOH was added to deprotonate the amino acid. Then, 1.5 grams of the potassium N-tert-butylglycinate solution (10 wt. %) was added to 23.1 grams of 100% glutaraldehyde-crosslinked PVA (3.7 wt. %).

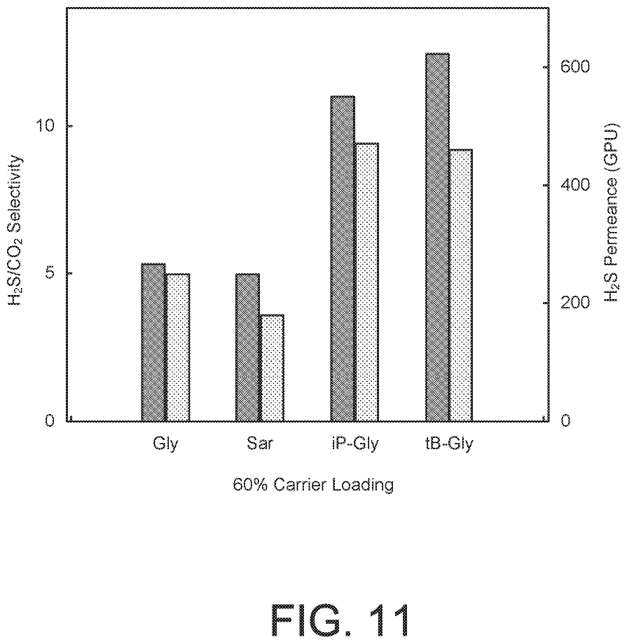

The coating solutions thus prepared were purged under nitrogen to improve the viscosity. The solution was centrifuged at 3000 rpm for 5 minutes to remove any bubbles before coating. The solution was coated on to the nanoporous polysulfone support with a GARDCO adjustable micrometer film applicator (Paul N. Gardner Company) with the gap setting held at 10 mil. The membrane was dried in a fume hood for half an hour and then held at 120° C. in a muffle furnace for 6 hours to complete the crosslinking. The membranes were tested at 107° C. and 7 bar feed pressure in the gas permeation apparatus. The feed gas consisted of 80% CO₂, 1% H₂S, and 19% H₂O. The results are presented in FIG. 11.

The H₂S/CO₂ selectivity and H₂S permeance results were observed to increase as the steric hindrance increased. The unhindered and mildly hindered carriers, i.e., glycinate and sarcosinate, respectively, showed lower selectivities and H₂S permeances compared to the carriers with a higher degree of hindrance and substitution, i.e., N-isopropylglycinate and N-tert-butylglycinate. The glycinate and sarcosinate showed poor selectivities of around 5.

By contrast, the more hindered carriers, N-isopropylglycinate and N-tert-butylglycinate, showed much higher selectivities of 11 and 12.4, respectively. Similarly, for the H₂S permeances, the glycinate and sarcosinate showed H₂S permeances of 250 GPU and 180 GPU, respectively (GPU=gas permeation unit, 1 GPU=10⁻⁶ cm³(STP) cm⁻² s⁻¹ cmHg⁻¹), while N-isopropylglycinate and N-tert-butylglycinate showed higher permeances of 470 GPU and 460 GPU, respectively. These results indicate that increasing the steric hindrance successfully retarded the amine-CO₂ reaction while allowing for the amine-H₂S reaction.

### Example 2—Group 2 Membranes

In this example, the potassium salts of glycine, sarcosine, N-isopropylglycine and N-tert-butylglycine (structures shown previously in FIG. 10), were incorporated into the membranes at an increased carrier loading of 70 wt. % in each of the membranes. The membrane selective layer consisted of the crosslinked PVA and the potassium salt of the amino acid.

In order to prepare the coating solution containing 70% potassium glycinate, a 19 wt. % carrier solution of potassium glycinate was prepared by dissolving 1.34 grams of glycine in 10.2 grams of water. 1.1 grams of KOH was added to deprotonate the amino acid. Then, 0.8 grams of the potassium glycinate solution (19 wt. %) was added to 1.65 grams of 100% glutaraldehyde-crosslinked PVA (3.9 wt. %).

Similarly, for preparing the coating solution containing 70% potassium sarcosinate, a 22 wt. % carrier solution of potassium sarcosinate was prepared by dissolving 1 grams of sarcosine in 6 grams of water. 0.75 grams of KOH was added to deprotonate the amino acid. Then, 1 grams of the potassium sarcosinate solution (22 wt. %) was added to 3.1 grams of 100% glutaraldehyde-crosslinked PVA (3.1 wt. %).

Also, similarly, for preparing the coating solution containing 70% potassium N-isopropylglycinate, a 9 wt. % carrier solution was prepared by dissolving 0.3 grams of N-isopropylglycine in 4 grams of water. 0.15 grams of KOH was added to deprotonate the amino acid. Then, 1.67 grams of the potassium N-isopropylglycinate (9 wt. %) was added to 1.6 grams of 100% glutaraldehyde-crosslinked PVA (3.9 wt. %).

Again similarly, for preparing the coating solution containing 70% potassium N-tert-butylglycinate, a 10 wt. % carrier solution of potassium N-tert-butylglycinate was prepared by dissolving 0.44 grams of N-tert-butylglycine in 5.1 grams of water. 0.2 grams of KOH was added to deprotonate the amino acid. Then, 2.1 grams of the potassium N-tert-butylglycinate solution (10 wt. %) was added to 2.5 grams of 100% glutaraldehyde-crosslinked PVA (3.9 wt. %).

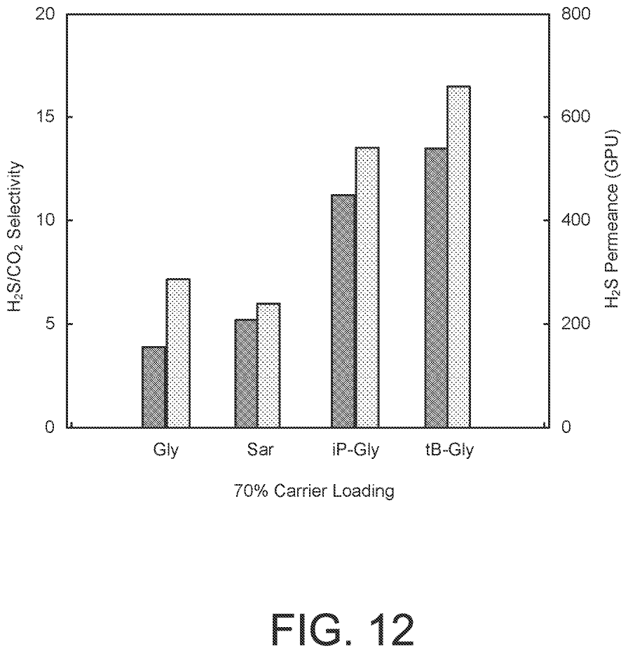

The coating solutions thus prepared were purged under nitrogen to improve the viscosity. The solution was centrifuged at 3000 rpm for 5 minutes to remove any bubbles before coating. The solution was coated on to the nanoporous polysulfone support with a GARDCO adjustable micrometer film applicator (Paul N. Gardner Company) with the gap setting held at 10 mil. The membrane was dried in a fume hood for half an hour and then held at 120° C. in a muffle furnace for 6 hours to complete the crosslinking. The membranes were tested at 107° C. and 7 bar feed pressure in the gas permeation apparatus. The feed gas consisted of 80% CO₂, 1% H₂S, and 19% H₂O. The results are presented in FIG. 12.

Once again, the trend of increasing H₂S/CO₂ selectivity and H₂S permeance with an increase in steric hindrance was observed. Again, a demarcation could be observed between the unhindered and mildly hindered carriers, i.e., glycinate and sarcosinate, respectively, and the carriers with a higher degree of hindrance and substitution, i.e., N-isopropylglycinate and N-tert-butylglycinate. The glycinate and sarcosinate carriers with a lower degree of steric hindrance showed poor selectivities of 3.9 and 5.2, respectively. In comparison, the hindered carriers, N-isopropylglycinate and N-tert-butylglycinate, showed much higher selectivities of 11.2 and 13.5, respectively. Similarly, for the H₂S permeances, the glycinate and sarcosinate showed H₂S permeances of below 300 GPU, while N-isopropylglycinate and N-tert-butylglycinate showed much higher permeances of 540 GPU and 660 GPU, respectively. Again, these results indicate that increasing the steric hindrance allowed us to improve the H₂S/CO₂ transport performance.

### Example 3

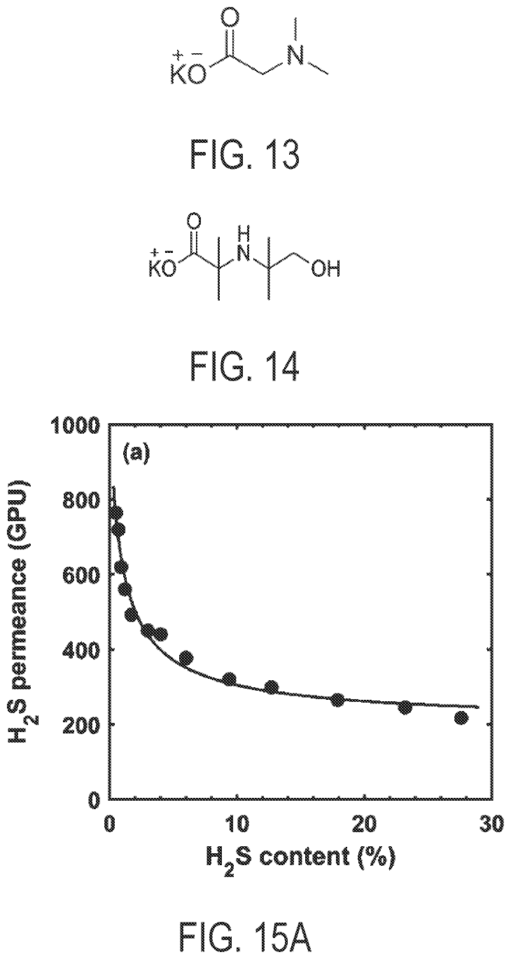

In Example 3, a 3° amino acid salt, potassium N,N-dimethylglycinate (FIG. 13) was incorporated into the membranes at 60% and 70% carrier loadings, respectively. The membrane selective layer consisted of the crosslinked PVA and the potassium salt of the 3° amino acid.

The carrier solution was prepared by dissolving 0.74 grams of N,N-dimethylglycine in 5.6 grams of water. 0.45 grams of potassium hydroxide was added to deprotonate the amino acid to generate a 16.7 wt. % carrier solution. The coating solution was prepared by blending the carrier solution with the aqueous solution of the crosslinked PVA (3.8 wt. %). The coating solution was then purged under nitrogen to improve the solid content and hence the viscosity. The solution was centrifuged at 3000 rpm for 5 minutes to remove any bubbles before coating. The solution was coated on to the nanoporous polysulfone support with a GARDCO adjustable micrometer film applicator (Paul N. Gardner Company) with the gap setting held at 15 mil. The membrane was dried in a fume hood for half an hour and then held at 120° C. in a muffle furnace for 6 hours to complete the crosslinking. The membrane was tested at 107° C. and 6 bar feed pressure in the gas permeation apparatus. The feed gas consisted of 80% CO₂, 19% H₂O, and 1% H₂S.

The membranes showed enhanced H₂S/CO₂ selectivities and permeances. The membrane containing 60% of potassium N,N-dimethylglycinate showed an H₂S/CO₂ selectivity of 17.7 and an H₂S permeance of 740 GPU. At an increased carrier loading of 70%, the membrane showed an H₂S/CO₂ selectivity of 16.5 and an H₂S permeance of 770 GPU. The drop in the selectivity at a higher carrier loading came from the increased CO₂ permeance, suggesting that although selective for H₂S, the carrier was also facilitating the transport of CO₂. The results are tabulated in the table below.

Transport results of membranes containing potassium N,N-dimethylglycinate.

| Membrane Carrier | | H₂S/CO₂ | H₂S Permeance |
|---|---|---|---|
| Loading | Thickness | Selectivity | (GPU) |
| 60% potassium | 10 μm | 17.7 | 740 |
| N,N-dimethylglycinate | | | |
| 70% potassium | 10 μm | 16.5 | 770 |
| N,N-dimethylglycinate | | | |

### Example 4

In this example, the potassium salt of N-(1,1-dimethyl-2-hydroxyethyl)-aminoisobutyric acid (tB-AIBA, see FIG. 14), a sterically hindered 2° amino acid with a polar hydrophilic side chain, was incorporated as a mobile carrier into the membrane at 70% carrier loading. The membrane selective layer included crosslinked PVA and the potassium salt of N-(1,1-dimethyl-2-hydroxyethyl)-aminoisobutyrate (tB-AIBA).

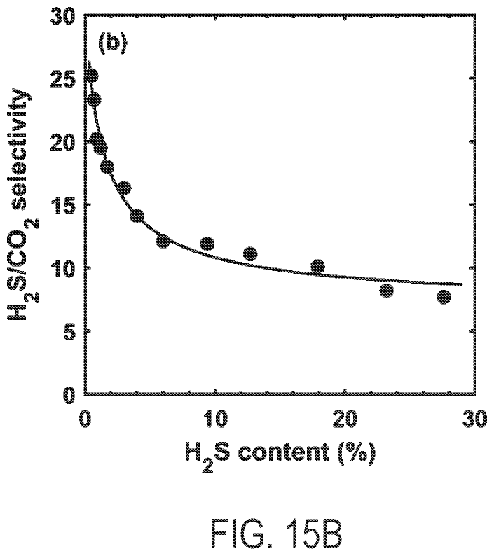

The carrier solution was prepared by dissolving 0.55 grams of N-(1,1-dimethyl-2-hydroxyethyl)-aminoisobutyric acid in 4.8 grams of water. A stoichiometric amount of potassium hydroxide was added to deprotonate the amino acid to generate a 12 wt. % carrier solution. The coating solution was prepared by blending in 2.3 grams of the carrier solution (12 wt. %) into 2.5 grams of glutaraldehyde crosslinked PVA (4.5%). The coating solution was then purged under nitrogen to improve the solid content and hence the viscosity. The solution was centrifuged at 3000 rpm for 5 minutes to remove any bubbles before coating. The solution was coated on to the nanoporous polysulfone support with a GARDCO adjustable micrometer film applicator (Paul N. Gardner Company) with the gap setting held at 10 mil. The membrane was dried in a fume hood for half an hour and then held at 120° C. in a muffle furnace for 6 hours to complete the crosslinking. The membrane was tested at 107° C. and 6 bar feed pressure in the gas permeation apparatus. The membrane was tested at various feed H₂S contents. The results are presented in FIG. 15.

The H₂S permeance dropped from around 750 GPU at 0.5% H₂S to around 217 GPU at 27% H₂S. Similarly, the H₂S/CO₂ selectivity reduced from 25.2 at 0.5% H₂S to around 8 at 27% H₂S. This trend in the H₂S performance is attributed to the carrier saturation phenomenon. At the higher H₂S partial pressure, the amount of the H₂S-amine reaction product was more whereas the amount of the free carrier molecules available for reaction with H₂S was less, causing a corresponding drop in the permeance. Conversely, lowering the feed H₂S partial pressure resulted in an increased H₂S permeance due to an increase in the number of free carrier molecules. By contrast, the CO₂ permeance did not show any indication of carrier saturation and remained constant at around 30 GPU. This indicates that the transport of CO₂ across the membrane is based on the solution-diffusion mechanism, rather than the facilitated transport, i.e., the carrier is not reacting with CO₂. In other words, the highly hindered carrier structure allowed the reactive transport of H₂S while being nearly inert to CO₂.

### REFERENCES

[1]K. Ramasubramanian, Y Zhao, W. S. W. Ho, CO₂ capture and H₂ purification: Prospects for CO₂-selective membrane processes, AIChE J. 59 (2013) 1033-1045. https://doi.org/10.1002/aic.14078.
[2]L. Ansaloni, Y Zhao, B. T. Jung, K. Ramasubramanian, M. G. Baschetti, W. S. W. Ho, Facilitated transport membranes containing amino-functionalized multi-walled carbon nanotubes for high-pressure CO₂ separations, J. Membr. Sci. 490 (2015) 18-28. https://doi.org/10.1016/j.memsci.2015.03.097.
[3]Y Zhao, B. T. Jung, L. Ansaloni, W. S. W. Ho, Multiwalled carbon nanotube mixed matrix membranes containing amines for high pressure CO₂/H₂ separation, J. Membr. Sci. 459 (2014) 233-243. https://doi.org/10.1016/j.memsci.2014.02.022.
[4]V. Vakharia, K. Ramasubramanian, W. S. W. Ho, An experimental and modeling study of CO₂-selective membranes for IGCC syngas purification, J. Membr. Sci. 488 (2015) 56-66. https://doi.org/10.1016/j.memsci.2015.04.007.
[5]W. Salim, W. S. W. Ho, Hydrogen purification with CO₂-selective facilitated transport membranes, Curr. Opin. Chem. Eng. 21 (2018) 96-102. https://doi.org/10.1016/j.coche.2018.09.004.
[6]M. Caplow, Kinetics of carbamate formation and breakdown, J. Am. Chem. Soc. 90 (1968) 6795-6803. https://doi.org/10.1021/ja01026a041.
[7]P. V Danckwerts, The reaction of CO₂ with ethanolamines, Chem. Eng. Sci. 34 (1979) 443-446. https://doi.org/10.1016/0009-2509(79)85087-3.
[8]G. Sartori, D. W. Savage, Sterically hindered amines for carbon dioxide removal from gases, Ind. Eng. Chem. 22 (1983) 239-249. https://pubs.acs.org/doi/pdf/10.1021/i100010a016.
[9]G. Sartori, W. S. W. Ho, D. W. Savage, G. R. Chludzinski, S. Wlechert, Sterically-hindered amines for acid-gas absorption, Sep. Purif. Methods. 16 (1987) 171-200. https://doi.org/10.1080/03602548708058543.
[10]A. K. Saha, S. S. Bandyopadhyay, P. Saju, A. K. Biswas, Selective removal of hydrogen sulfide from gases containing hydrogen sulfide and carbon dioxide by absorption into aqueous solutions of 2-amino-2-methyl-1-propanol, Ind. Eng. Chem. Res. 32 (1993) 3051-3055. https://doi.org/10.1021/ie00024a013.
[11]B. P. Mandal, A. K. Biswas, S. S. Bandyopadhyay, Selective absorption of H₂S from gas streams containing H₂S and CO₂ into aqueous solutions of N-methyldiethanolamine and 2-amino-2-methyl-1-propanol, Sep. Purif. Technol. 35 (2004) 191-202. https://doi.org/10.1016/S1383-5866(03)00139-4.
[12]J.-G. Lu, Y-F. Zheng, D.-L. He, Selective absorption of H₂S from gas mixtures into aqueous solutions of blended amines of methyldiethanolamine and 2-tertiarybutylamino-2-ethoxyethanol in a packed column, Sep. Purif. Technol. 52 (2006) 209-217. https://doi.org/10.1016/j.seppur.2006.04.003.
[13]W. Hu, A. Chakma, Modelling of equilibrium solubility of CO₂ and H₂S in aqueous amino methyl propanol (AMP) solutions, Chem. Eng. Commun. 94 (1990) 53-61. https://doi.org/10.1080/00986449008911455.
[14]W. S. W. Ho, G. Sartori, Addition of severely-hindered amine salts and/or aminoacids to non-hindered amine solutions for the absorption of H₂S, U.S. Pat. No. 4,892,674, 1990.
[15]T. Fout, A. Zoelle, D. Keairns, M. Turner, M. Woods, N. Kuehn, V. Shah, V. Chou, L. Pinkerton, J. Black, Cost and Performance Baseline for Fossil Energy Plants Volume 1b: Bituminous Coal (IGCC) to Electricity Revision 2b-Year Dollar Update, U.S. Department of Energy, Report Number: DOE/NETL-2015/1727, Washington, DC, USA, 2015.
[16]Y Han, W. S. W. Ho, Facilitated transport membranes for H₂ purification from coal-derived syngas: A techno-economic analysis, J. Membr. Sci., 636 (2021) 119549. https://www.sciencedirect.com/science/article/pii/S0376738821004968

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A membrane comprising:
a support layer; and
a selective polymer layer disposed on the support layer, the selective polymer layer comprising a selective polymer matrix,
wherein the selective polymer matrix comprises a mobile carrier comprising a sterically hindered amine.

2. The membrane of claim 1, wherein the mobile carrier has a molecular weight of less than 1,000 Da.

3. The membrane of any one of claims 1-2, wherein the mobile carrier comprises a sterically hindered amino acid.

4. The membrane of any one of claims 1-3, wherein the mobile carrier is defined by the structure below: 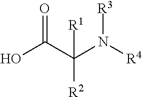
or a salt thereof, wherein
R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

5. The membrane of claim 4, wherein R¹ is selected from alkyl, alkenyl, alkynyl, cycloalkyl, heterocycloalkyl, aryl, and heteroaryl, each optionally substituted with one or more substituents individually chosen from R^{a}.

6. The membrane of claim 4 or 5, R¹ and R² are each independently selected from alkyl, alkenyl, alkynyl, cycloalkyl, heterocycloalkyl, aryl, and heteroaryl, each optionally substituted with one or more substituents individually chosen from R^{a}.

7. The membrane of any of claims 4-6, wherein R³ is hydrogen.

8. The membrane of any of claims 4-6, wherein R³ and R⁴ are each independently selected from alkyl, alkenyl, alkynyl, cycloalkyl, heterocycloalkyl, aryl, and heteroaryl, each optionally substituted with one or more substituents individually chosen from R^{a}.

9. The membrane of claim 4, wherein the mobile carrier is defined by the structure below: 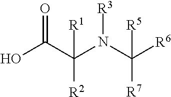
or a salt thereof, wherein
R¹ and R² are independently selected from hydrogen, alkyl, alkenyl, alkynyl, cycloalkyl, heterocycloalkyl, aryl, and heteroaryl, each optionally substituted with one or more substituents individually chosen from R^{a};
R³ is selected from hydrogen, alkyl, alkenyl, alkynyl, cycloalkyl, heterocycloalkyl, aryl, and heteroaryl, each optionally substituted with one or more substituents individually chosen from R^{a};
R⁵ and R⁶ are independently selected from hydrogen, alkyl, alkenyl, alkynyl, cycloalkyl, heterocycloalkyl, aryl, and heteroaryl, each optionally substituted with one or more substituents individually chosen from R^{a};
R⁷ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

10. The membrane of claim 9, wherein R¹ is selected from alkyl, alkenyl, alkynyl, cycloalkyl, heterocycloalkyl, aryl, and heteroaryl, each optionally substituted with one or more substituents individually chosen from R^{a}.

11. The membrane of claim 9 or 10, R¹ and R² are each independently selected from alkyl, alkenyl, alkynyl, cycloalkyl, heterocycloalkyl, aryl, and heteroaryl, each optionally substituted with one or more substituents individually chosen from R^{a}.

12. The membrane of any of claims 9-11, wherein R³ is hydrogen.

13. The membrane of any of claims 9-11, wherein R³ is selected from alkyl, alkenyl, alkynyl, cycloalkyl, heterocycloalkyl, aryl, and heteroaryl, each optionally substituted with one or more substituents individually chosen from R^{a}.

14. The membrane of any of claims 9-13, wherein R⁵ is selected from alkyl, alkenyl, alkynyl, cycloalkyl, heterocycloalkyl, aryl, and heteroaryl, each optionally substituted with one or more substituents individually chosen from R^{a}.

15. The membrane of any of claims 9-14, R⁵ and R⁶ are each independently selected from alkyl, alkenyl, alkynyl, cycloalkyl, heterocycloalkyl, aryl, and heteroaryl, each optionally substituted with one or more substituents individually chosen from R^{a}.

16. The membrane of any one of claims 1-3, wherein the mobile carrier is defined by the structure below: 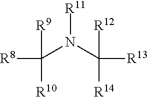
or a salt thereof, wherein
R¹ and R⁹ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁰ is selected from alkyl, alkenyl, alkynyl, cycloalkyl, heterocycloalkyl, aryl, and heteroaryl, each optionally substituted with one or more substituents individually chosen from R^{a};
R¹¹ is selected from hydrogen, alkyl, alkenyl, alkynyl, cycloalkyl, heterocycloalkyl, aryl, and heteroaryl, each optionally substituted with one or more substituents individually chosen from R^{a};
R¹² and R¹³ are independently selected from hydrogen, alkyl, alkenyl, alkynyl, cycloalkyl, heterocycloalkyl, aryl, and heteroaryl, each optionally substituted with one or more substituents individually chosen from R^{a};
R¹⁴ is selected from alkyl, alkenyl, alkynyl, cycloalkyl, heterocycloalkyl, aryl, and heteroaryl, each optionally substituted with one or more substituents individually chosen from R^{a}; and
R^{a} is chosen from hydroxy, halogen, —CN, —NO₂, amino, alkylamino, dialkylamino, alkyl, alkoxy, alkenyl, alkynyl, alkylcarbonyl, alkoxycarbonyl, alkylaminocarbonyl, and dialkylaminocarbonyl.

17. The membrane of claim 16, wherein R⁸ is selected from alkyl, alkenyl, alkynyl, cycloalkyl, heterocycloalkyl, aryl, and heteroaryl, each optionally substituted with one or more substituents individually chosen from R^{a}.

18. The membrane of claim 16 or 17, R⁸ and R⁹ are each independently selected from alkyl, alkenyl, alkynyl, cycloalkyl, heterocycloalkyl, aryl, and heteroaryl, each optionally substituted with one or more substituents individually chosen from R^{a}.

19. The membrane of any of claims 16-18, wherein R¹¹ is hydrogen.

20. The membrane of any of claims 16-18, wherein R¹¹ is selected from alkyl, alkenyl, alkynyl, cycloalkyl, heterocycloalkyl, aryl, and heteroaryl, each optionally substituted with one or more substituents individually chosen from R^{a}.

21. The membrane of any of claims 16-20, wherein R¹² is selected from alkyl, alkenyl, alkynyl, cycloalkyl, heterocycloalkyl, aryl, and heteroaryl, each optionally substituted with one or more substituents individually chosen from R^{a}.

22. The membrane of any of claims 16-21, R¹² and R¹³ are each independently selected from alkyl, alkenyl, alkynyl, cycloalkyl, heterocycloalkyl, aryl, and heteroaryl, each optionally substituted with one or more substituents individually chosen from R^{a}.

23. The membrane of any of claims 1-22, wherein the mobile carrier is one of the following

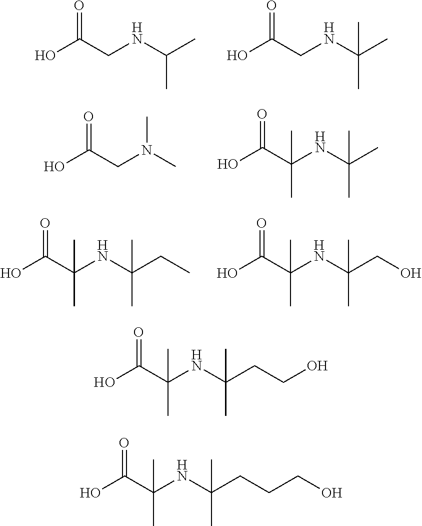

24. The membrane of any one of claims 1-23, wherein the selective polymer matrix further comprises a hydrophilic polymer, a cross-linking agent, amine-containing polymer, or a combination thereof.

25. The membrane of any one of claims 1-24, wherein the selective polymer matrix comprises a hydrophilic polymer and a cross-linking agent.

26. The membrane of any one of claims 24-25, wherein the cross-linking agent is selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, an aminosilane cross-linking agent, and combinations thereof.

27. The membrane of any one of claims 24-26, wherein the hydrophilic polymer comprises a polymer selected from the group consisting of polyvinylalcohol, polyvinylacetate, polyethylene oxide, polyvinylpyrrolidone, polyacrylamine, and copolymers thereof, or blends thereof.

28. The membrane of any one of claims 1-27, wherein the selective polymer matrix further comprises an amine-containing polymer.

29. The membrane of claim 28, wherein the amine-containing polymer is selected from the group consisting of polyvinylamine, polyallylamine, polyethyleneimine, poly-N-methylvinylamine, poly-N-ethylvinylamine, poly-N-propylvinylamine, poly-N-isopropylvinylamine, poly-N-isobutylvinylamine, poly-N-tert-butylvinylamine, poly-N,N-dimethylvinylamine, poly-N,N-diethylvinylamine, poly-N-isopropylallylamine, poly-N-isobutylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

30. The membrane of any of claims 1-29, wherein the support layer comprises a gas permeable polymer.

31. The membrane of claim 30, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

32. The membrane of claim 31, wherein the gas permeable polymer comprises polyethersulfone or polysulfone.

33. The membrane of any of claims 1-32, wherein the support layer comprises a gas permeable polymer disposed on a base.

34. The membrane of claim 33, wherein the base comprises a non-woven fabric.

35. The membrane of claim 34, wherein the non-woven fabric comprises fibers formed from a polyester.

36. The membrane of any of claims 1-35, wherein the membrane is configured in a flat sheet, a spiral-wound, a hollow fiber, or a plate-and-frame configuration.

37. The membrane of any one of claims 1-36, wherein the membrane is selectively permeable to hydrogen sulfide.

38. The membrane of any of claims 1-37, wherein the membrane has a H₂S:CO₂ selectivity of at least 5 at 107° C. and 35 bar feed pressure.

39. The membrane of any of claims 1-38, wherein the membrane has a H₂S:CO₂ selectivity of from 5 to 50 at 107° C. and 35 bar feed pressure.

40. The membrane of any one of claims 1-39, wherein the membrane has a H₂S permeance of at least 300 GPU at 107° C. and 35 bar feed pressure.

41. The membrane of any one of claims claim 1-40, wherein the membrane has a H₂S permeance of from 300 GPU to 1000 GPU at 107° C. and 35 bar feed pressure.

42. The membrane of any one of claims 1-41, wherein the membrane has a CO₂ permeance of 200 GPU or less at 107° C. and 35 bar feed pressure.

43. The membrane of any one of claims 1-41, wherein the membrane has a CO₂ permeance of 100 GPU or less at 107° C. and 35 bar feed pressure.

44. A method for separating H₂S gas from a feed gas stream comprising H₂S and CO₂, the method comprising contacting a membrane defined by any of claims 1-43 with the feed gas stream comprising the H₂S under conditions effective to afford transmembrane permeation of the H₂S.

45. The method of claim 44, wherein the feed gas comprises syngas or processed syngas.

46. The method of any of claims 44-45, wherein the first gas stream has a temperature of at least 100° C., such as at least 107° C.

47. The method of any of claims 44-45, wherein the first gas stream has a temperature of from greater than 100° C. to 180° C.

48. The method of any of claims 44-47, wherein the first gas stream has a pressure of at least 35 bar.
